(19) United States
(12) Patent Application Publication
(10) Pub. No.: US 2014/0065583 A1
(43) Pub. Date: Mar. 6, 2014

(54) INTRA-OPERATIVE FIRE/SMOKE SIMULATION DEVICE

(71) Applicant: The Johns Hopkins University, Baltimore, MD (US)

(72) Inventor: Robert S. Greenberg, Glenelg, MD (US)

(73) Assignee: The Johns Hopkins University, Baltimore, MD (US)

(21) Appl. No.: 14/017,687

(22) Filed: Sep. 4, 2013

Related U.S. Application Data
(60) Provisional application No. 61/696,470, filed on Sep. 4, 2012.

(51) Int. Cl. G09B 19/00

(52) U.S. Cl. CPC G09B 19/00
USPC 434/219

(57) ABSTRACT

A simple, low-cost but extremely effective means to represent an intraoperative (for example) fire that highlights recognition using multi-sensual stimulation. The device can be used as part of a high fidelity simulation program that includes an explosion (sound), profuse smoke (visual), and odor (smells) to simulate an intraoperative fire. The design is re-usable, simple to set up, and does not use toxic agents (either to participants or mannequin).

### CROSS REFERENCE TO RELATED APPLICATIONS

This application claims the benefit of U.S. Provisional Patent Application No. 61/696,470, filed on Sep. 4, 2012, which is incorporated by reference herein in its entirety. U.S. Provisional Patent Application No. 61/525,026 is also incorporated by reference herein in its entirety.

### FIELD OF THE INVENTION

The present invention pertains to an intra-operative fire/smoke simulation device. More particularly, the present invention pertains to an intra-operative fire/smoke simulation device for training new physicians and the like.

### BACKGROUND OF THE INVENTION

Modern medical education utilizes high fidelity simulation to permit students to experience a variety of potentially lethal and/or infrequent situations in a safe, reproducible, and regimented manner to elucidate key factors in mitigation risk as well as to develop and maintain skills for a proper response. However, there has yet to be developed a device that simulates an intraoperative fire.

Accordingly, there is a need in the art for a system and method for simulating an intraoperative fire.

### SUMMARY

According to a first aspect of the present invention, an intra-operative smoke simulation device comprises a container for simulating smoke, the container including a bottom reservoir and a top reservoir. The bottom reservoir contains vinegar and the top reservoir includes dry ice. A releasable partition is disposed between the top reservoir and the bottom reservoir. A smoke generator trigger releases the partition so that the dry ice is directed into the bottom reservoir thereby causing a reaction that simulates smoke. A tube is connected to the container for transferring the smoke to an area of interest.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and:

FIG. 1 illustrates a perspective view of an exemplary product according to the features of the present invention.

### DETAILED DESCRIPTION OF THE PREFERRED EMBODIMENTS

The presently disclosed subject matter now will be described more fully hereinafter with reference to the accompanying Drawings, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

The present invention pertains to a system and method for intra-operative fire/smoke simulation device which is simple, low-cost, and extremely effective for simulating an intraoperative (for example) fire using multi-sensual stimulation. The device can be used as part of a high fidelity simulation program that includes an explosion (sound), profuse smoke (visual), and odor (smells) to simulate an intraoperative fire. The design is re-usable, simple to set up, and does not use toxic agents (either to participants or mannequin).

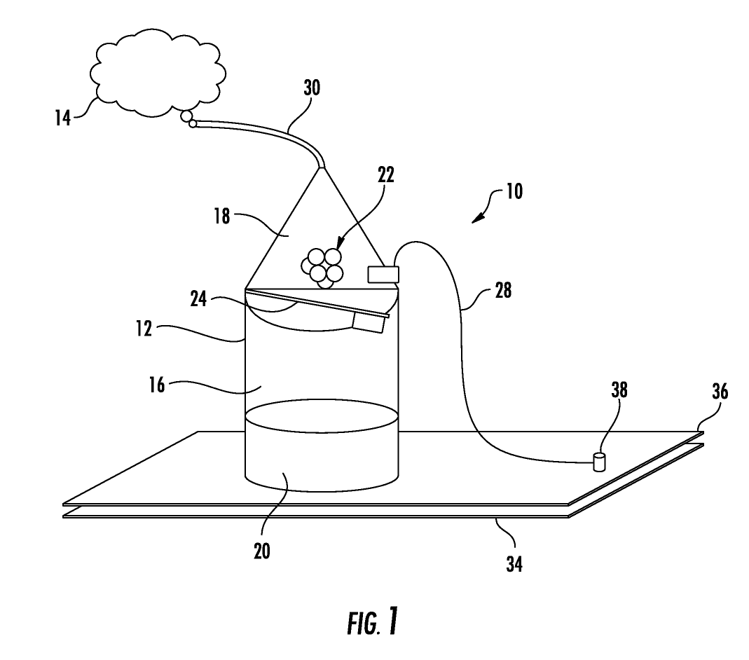

With reference to FIG. 1, an intra-operative smoke simulation device 10 includes a container 12 for producing smoke 14 for a simulation. The container 12 includes a partition 24. The partition 24 can be horizontal or vertical and can split the container into two reservoirs of varying or equal size. In one exemplary embodiment, illustrated in FIG. 1, the container 12 includes a bottom reservoir 16 and a top reservoir 18, created by partition 24. In the exemplary embodiment, the bottom reservoir 16 contains vinegar 20 and the top reservoir 18 includes dry ice 22. However, any suitable combination of chemicals or activators that produce smoke and particularly smoke that is acidic in smell. For instance, the top reservoir can contain a substance and the second reservoir can be in contact with an activator for the substance, such as light or electricity. No matter the substance and activator chosen, the smoke is preferably configured to mimic smoke produced during an intraoperative fire.

The partition 24 is disposed between the top reservoir 18 and the bottom reservoir 16 to prevent the dry ice 22 and vinegar 20 from mixing until the simulation device 10 is triggered. In a preferred embodiment, the partition 24 can take the form of a releasable partition or a partition with a releasable portion. A smoke generator trigger 28 is provided for releasing the partition 24 so that the dry ice 22 is directed into the bottom reservoir 16 thereby causing a reaction that simulates intraoperative smoke. A tube 30 is connected to the container for directing the smoke to an area of interest.

A high energy device 34 is provided to create a snap and activate the smoke simulation device 10. In a preferred embodiment, the high energy device 34 is a mouse trap. To activate the device 34, a string 36 is attached to the high energy device 34 in such a way to cause the high energy device 34 to operate. Preferably, an explosive blank 38 is positioned adjacent to the high energy device 34 (in this case, a mouse trap) for causing a louder cracking sound simulating an intraoperative explosion. Alternately, the high energy device can be actuated electronically or in some embodiments the high energy device can take the form of an electronic high energy device, preferably containing a computing device or microprocessor, configured to simulate the sounds of an intraoperative explosion and is also configured to activate the smoke event.

To operate the device, the string 36 is pulled, causing the mouse trap 34 to close onto explosion blank 38, thereby causing a large cracking sound. Closing of the mouse trap 34 causes string 28 to be pulled, thereby releasing partition 24, which causes the dry ice 22 in top reservoir 18 to drop into the vinegar 20 in the bottom reservoir 18. The reaction of dry ice and vinegar causes a smoke-like reaction. A tube 30 is connected to the container 12, and is directed to a mannequin used for intra-operative training Accordingly, a significant amount of “smoke” is directed through the mannequin and comes out through the mannequin's mouth, nose, and/or airway tube. The dry ice/vinegar mixture has an acidic smell, and is very similar to the burning PVC/plastic found in an airway. While vinegar and dry ice have been described as creating the smoke-like reaction, other mixtures are also possible.

In practice, during a simulation, such as a surgical simulation, the student will hear the crack of an explosion, see the smoke, and smell the rancid product of burning plastic. The device produces a high fidelity simulation of an intra-operative fire using audile, visual and olfactory senses. The smoke produced is not harmful to the student or mannequin. The device can be used in several different types of simulation events known to or conceivable by one of skill in the art. For instance, the device can be used to trigger a surprise intraoperative fire event, during an otherwise routine surgical simulation to teach or test students' reactions to unexpected situations. The device could alternately be used in a simulation geared toward teaching different ways to react in an intraoperative fire event, as well as to demonstrate or model ways not to react in such a situation. It therefore may be preferable to configure the device in such a way that it can be concealed from students or other users during an intraoperative fire simulation.

It should also be noted that the device can be configured such that it is cleanable and reusable and is preferably made from materials that facilitate the device's reusability. It is also possible that certain parts of the device that experience greater wear can be replaced in order to increase the longevity of the device in its preferred embodiment. Therefore, elements such as the mouse trap, plastic tubing, trigger, and string can easily be replaced multiple times, such that the device can be reused for many simulations.

The device is intended to be used in a simulation environment to present, using multi-sensory stimulation, a high fidelity experience for explosion, fire, and smoke. Although described above as an airway fire, the present invention could also be applied to training for simulating various surgical fire events, such as a fire in the drapes and/or equipment.

Although the present invention has been described in connection with preferred embodiments thereof, it will be appreciated by those skilled in the art that additions, deletions, modifications, and substitutions not specifically described may be made without departing from the spirit and scope of the invention as defined in the appended claims.

1. An intra-operative smoke simulation device, comprising:
a container for simulating smoke, said container including a first reservoir and a second reservoir, wherein the first reservoir is filled with a first contents and the second reservoir is filled with a second contents, and wherein the first contents are reactive with the second contents;
a releasable partition disposed between said first reservoir and said second reservoir;
a smoke generator trigger for releasing said partition so that the first contents come into contact with the second contents, thereby causing a reaction that simulates smoke; and
a tube connected to said container for transferring the smoke to an area of interest.

2. The smoke simulation device of claim 1, further including an activating device to create a snap and activate the smoke simulation device.

3. The smoke simulation device of claim 2, wherein said activating device is a mouse or rat trap.

4. The smoke simulation device of claim 3, wherein an explosive blank is positioned adjacent to said mouse trap for causing a louder cracking sound simulating an intraoperative explosion.

5. The smoke simulation device of claim 2, further including a trigger for operating the activation device.

6. The smoke simulation device of claim 5, wherein said trigger is a string connecting one end of the activation device to said releasable partition.

7. The smoke simulation device of claim 2, wherein said smoke generator trigger is a string connected to said activation device to thereby activate said activation device.

8. The smoke simulation device of claim 2, wherein the activation device comprises an electronic device.

9. The smoke simulation device of claim 8 wherein the activation device comprises one selected from a group consisting of a computing device and a microprocessor.

10. The smoke simulation device of claim 1 wherein the first contents comprise dry ice and the second contents comprise vinegar.

11. The smoke simulation device of claim 1 wherein the second contents comprises an activator selected from a group consisting of light and electricity.

12. The smoke simulation device of claim 1 wherein the first reservoir is positioned on top of the second reservoir.

13. The smoke simulation device of claim 1 wherein the releasable partition comprises a portion of the partition that is releasable.

14. The smoke simulation device of claim 1 wherein the releasable partition is completely releasable.

15. A method of simulating an intraoperative fire for training students and practitioners comprising:
providing a container for simulating smoke, said container being configured to hold a reactive substance in a holding area;
triggering a change in the configuration of the container for simulating smoke such that the reactive substance can be activated;
activating the reactive substance such that smoke is produced; and
directing the smoke to a desired area in order to simulate the intraoperative fire.

16. The method of simulating intraoperative fire of claim 15 further comprising generating sounds to simulate the intraoperative fire.

17. The method of simulating intraoperative fire of claim 15 further comprising releasing a partition that separates separate holding areas of the container such that more than one reactive substance can be combined to produce the smoke.

18. The method of simulating intraoperative fire of claim 15 further comprising providing a container for simulating smoke, said container being configured to hold reactive substances in separate holding areas, and wherein a first reactive substance is dry ice and a second reactive substance is vinegar.

19. The method of simulating intraoperative fire of claim 15 further comprising using tubing to direct the smoke to the desired area in order to simulate the intraoperative fire.

20. The method of simulating intraoperative fire of claim 15 further comprising using a triggering device to generate sounds to simulate the intraoperative fire as well as to initiate the smoke.
